(19) United States
(12) Patent Application Publication
(10) Pub. No.: US 2016/0104120 A1
(43) Pub. Date: Apr. 14, 2016

(54) METHOD AND APPARATUS FOR SCHEDULING PROJECT MEETINGS

(71) Applicant: Google Technology Holdings LLC, Mountain View, CA (US)

(72) Inventors: Amit Kumar Agrawal, Bangalore (IN); Raymond B. Essick, Glen Ellyn, IL (US); Mayank Gupta, Bangalore (IN); Lawrence A. Willis, McHenry, IL (US)

(21) Appl. No.: 14/510,274

(22) Filed: Oct. 9, 2014

(51) Int. Cl. G06Q 10/10; G06Q 10/06

(52) U.S. Cl. CPC G06Q 10/1095; G06Q 10/063116

(57) ABSTRACT

A method and apparatus for scheduling project meetings includes a meeting organizer module of an electronic computing device receiving, from a project manager module, a first criticality for a first task and a second criticality for a second task of a plurality of tasks for a project. The method also includes the meeting organizer module scheduling a project meeting for the project based on the first criticality and the second criticality, wherein scheduling the project meeting includes determining an ordered agenda in which presentations for tasks for the project are presented for the project meeting.

### FIELD OF THE DISCLOSURE

The present disclosure relates generally to a meeting organizer module of an electronic computing device scheduling a project meeting and more particularly to the meeting organizer module scheduling the project meeting by determining an ordered agenda for the project meeting.

### BACKGROUND

For the business community, great importance is placed on maximizing efficiency through time management. Efficiency is also valued in academia, government, and other venues for which groups of individuals collaborate on projects. To make work on a project more efficient, time-management tools are often used.

Time-management tools are effective in providing oversight for larger projects that involve numerous tasks, and potentially also subtasks. A time-management tool might provide a timetable for a project that includes defined stages of completion by mapping interdependencies and tracking progress for various tasks of the project. The time-management tool might also provide scheduling functionality whereby individuals associated with the project can meet and share information. Participants at a project meeting might present progress reports, identify issues affecting progress, and plan courses of action to deal with such issues.

While many time-management tools are well designed for efficiency in moving a project toward completeness, they are often less effective at bringing about personal productivity. Most participants for a project meeting, for instance, are only directly involved with a portion of the meeting.

### BRIEF DESCRIPTION OF THE FIGURES

The accompanying figures, where like reference numerals refer to identical or functionally similar elements throughout the separate views, form part of the specification and illustrate embodiments in accordance with the included claims.

FIG. 1 shows a system diagram that includes an electronic computing device with a meeting organizer module in accordance with some embodiments of the present teachings.

FIG. 2 shows a block diagram of hardware components of an electronic computing device in accordance with some embodiments of the present teachings.

FIG. 3 shows a logical flow diagram illustrating a method for scheduling a project meeting in accordance with some embodiments of the present teachings.

FIG. 4 shows a table indicating a criticality and at least one individual associated with each task of a project in accordance with some embodiments of the present teachings.

FIG. 5 shows a table representing a general project meeting consistent with prior art.

FIG. 6 shows a table displaying two ordered agendas for a project meeting in accordance with some embodiments of the present teachings.

FIG. 7 shows a table displaying two ordered agendas for a project meeting in accordance with some embodiments of the present teachings.

FIG. 8 shows a logical flow diagram illustrating a method for reducing a duration allotted for an un-presented presentation for a project meeting in accordance with some embodiments of the present teachings.

FIG. 9 shows a table displaying a reduced duration allotted for an un-presented presentation for a project meeting in accordance with some embodiments of the present teachings.

FIG. 10 shows a logical flow diagram illustrating a method for rescheduling an un-presented presentation for a project meeting in accordance with some embodiments of the present teachings.

FIG. 11 shows a table displaying a rescheduled presentation for a project meeting in accordance with some embodiments of the present teachings.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present teachings. In addition, the description and drawings do not necessarily require the order presented. It will be further appreciated that certain actions and/or steps may be described or depicted in a particular order of occurrence while those skilled in the art will understand that such specificity with respect to sequence is not actually required.

The apparatus and method components have been represented, where appropriate, by conventional symbols in the drawings, showing only those specific details that are pertinent to understanding the embodiments of the present disclosure so as not to obscure the disclosure with details that will be readily apparent to those of ordinary skill in the art having the benefit of the description herein.

### DETAILED DESCRIPTION

Generally speaking, pursuant to various embodiments described herein, the present disclosure provides a method and apparatus for scheduling a project meeting by determining an order of presentation for the project meeting. Presentations for tasks for a project are presented at the project meeting in an order that is based upon a criticality of each task. The order of presentation is also referred to herein as an “ordered agenda” and may be further based upon reducing a collective time that one or more participants of the project meeting are scheduled to be in attendance at the project meeting.

In accordance with the teachings herein, a method performed by a meeting organizer module of an electronic computing device for scheduling project meetings includes receiving, from a project manager module, a first criticality for a first task and a second criticality for a second task of a plurality of tasks for a project. The method additionally includes scheduling a project meeting for the project based on the first criticality and the second criticality, wherein scheduling the project meeting includes determining an ordered agenda in which presentations for tasks for the project are presented for the project meeting.

Also in accordance with the teachings herein is an electronic computing device configured for scheduling project meetings. The electronic computing device includes a meeting organizer module that is configured to receive, from a project manager module, a first criticality for a first task and a second criticality for a second task of a plurality of tasks for a project. The meeting organizer module is also configured to schedule a project meeting for the project based on the first criticality and the second criticality, wherein scheduling the project meeting includes determining an ordered agenda in which presentations for tasks for the project are presented for the project meeting.

An electronic computing device, also referred to herein simply as an electronic device, is defined as a device that operates on the principle of manipulating the flow of electrons and that can perform a programmed sequence of logical or mathematical operations. Types of electronic devices to which the present teachings may be applied include, but are not limited to: main frames, servers, desktop computers, laptops, tablets, phablets, smart phones, and personal digital assistants (PDAs).

A meeting organizer module (MOM) included within an electronic device as used herein includes one or more hardware components and also hardware- or software-based programming. At least one hardware component of the MOM is programmed to organize a project meeting by determining an ordered agenda for the project meeting. Additional hardware components of the MOM may support the at least one programmed hardware component in executing its programming.

In a first example, a MOM includes a microprocessor and a read-only memory (ROM) integrated circuit (IC). The ROM IC provides hardware-based programming to enable the microprocessor to organize a project meeting. In a second example, a MOM includes a microprocessor and a random-access memory (RAM) IC that provides software-based programming to enable the microprocessor to organize a project meeting. For instance, a software program is saved onto a hard drive of an electronic device and loaded into the RAM IC, which is accessed by the microprocessor in organizing a project meeting.

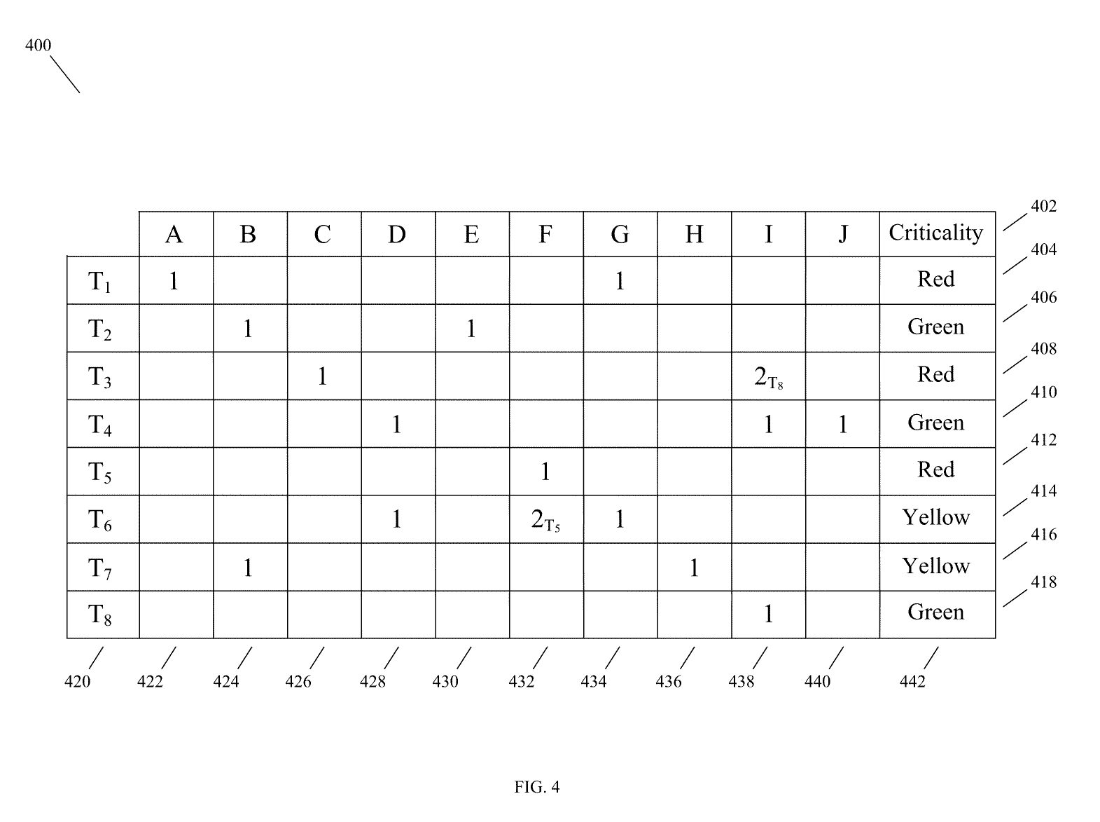

A project manager module (PMM) as used herein is one or more hardware components configured or programmed to track or determine a criticality for each task of a plurality of tasks associated with a project. A criticality of a task reflects an urgency or importance of addressing the task, such as at a project meeting, relative to other tasks. Criticalities of tasks are described in greater detail with reference to FIG. 4. For an embodiment, a PMM might include a processing element and memory.

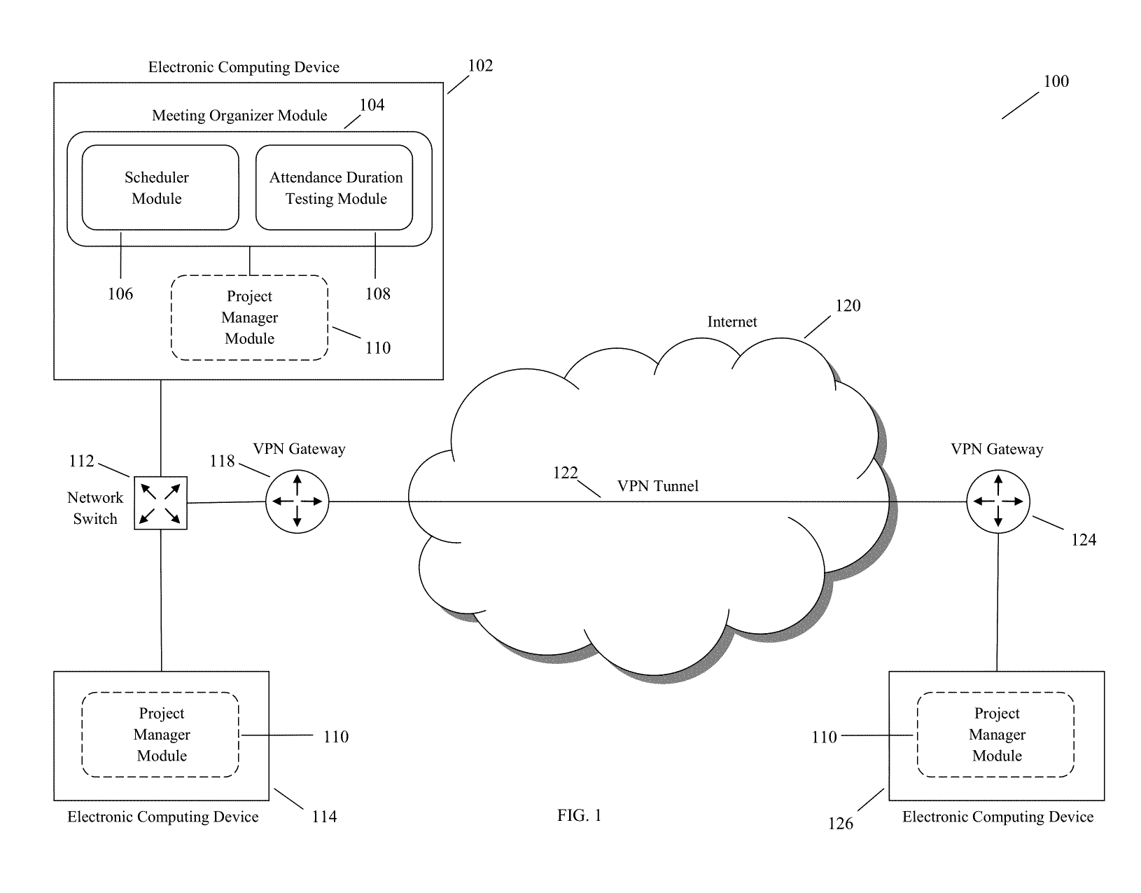

Referring now to the drawings, FIG. 1 shows a system diagram 100 illustrating locations of a PMM 110 relative to a MOM 104 for different embodiments. The diagram 100 includes three electronic devices 102, 114, 126, each serving as a possible location for the PMM 110. Electronic device 102, which includes the MOM 104, is coupled, either directly or through one or more intermediary devices, to a network switch 112 to which the electronic device 114 is also coupled. Connected to the network switch 112 is a router which serves as a virtual private network (VPN) gateway 118. A VPN tunnel 122 is established across the Internet 120 between the VPN gateway 118 and a VPN gateway 124, to which the electronic device 126 is coupled. The VPN tunnel 122 bridges a local area network (LAN), to which the electronic devices 102 and 114 belong to, and a LAN to which the electronic device 126 belongs.

In some embodiments, the PMM 110 is located within the same electronic device 102 as the MOM 104. For example, the PMM 110 and the MOM 104 are contained within a same housing. The PMM 110 and the MOM 104 may even share some or all of their hardware components. When the PMM 110 and the MOM 104 share the same hardware components, they are distinguished from one another by their programmed functionality. In a first embodiment, a microprocessor within the electronic device 102 is a hardware component of both the PMM 110 and the MOM 104. For a second embodiment, a first software program loaded into a first portion of RAM included in the electronic device 102 controls processing associated with the PMM 110 and a second software program loaded into a second portion of the RAM controls processing associated with the MOM 104. For a third embodiment, a primary microprocessor included within the electronic device 102 performs the processing of the PMM 110 while a secondary microprocessor included within the electronic device 102 performs the processing of the MOM 104.

In other embodiments, the PMM 110 is located within the electronic device 114 that belongs to the same LAN as the electronic device 102. The electronic device 102 and the electronic device 114 are each assigned a different Internet protocol (IP) address by the router 118 and communicate by exchanging data packets using a communication protocol such as transmission control protocol (TCP). For one embodiment, hardware components of a MOM and/or a PMM may be distributed over multiple electronic devices belonging to the same LAN. For example, the electronic device 102 may operate as a file server that provides hard-drive storage used by the PMM 110 located primarily within the electronic device 114 in performing its functionally. The MOM 104 can also read data stored by the PMM 110 on a hard drive of the electronic device 102 without exchanging messages with the electronic device 114.

In further embodiments, the PMM 110 is located within the electronic device 126 that belongs to a LAN different than the LAN to which the electronic device 102 housing the MOM 104 belongs. In performing their respective functionalities, the MOM 104, using communication hardware located within the electronic device 102, and the PMM 110, using communication hardware located within the electronic device 126, message by passing data packets across the Internet 120 using the TCP/IP protocol, for example.

Shown within the MOM 104 is a scheduler module (SM) 106 and an attendance duration testing module (ADTM) 108. The SM 106 is configured to determine an ordered agenda for a project meeting. For an embodiment, the SM 106 is also configured to receive availability information for participants of the project meeting from the PMM 110 and to determine the ordered agenda based on the availability information. From the ordered agenda, the ADTM 108 is configured to determine an individual time and/or a collective time that one or more of the participants of the project meeting are in attendance at the meeting. Both the SM 106 and the ADTM 108 are implemented, at least in part, by hardware of the electronic device 102. For example, one or more microprocessors of the electronic device 102 might enable the SM 106 and the ADTM 108 to perform their functionality. In different embodiments, that functionality might be programmed by firmware or software.

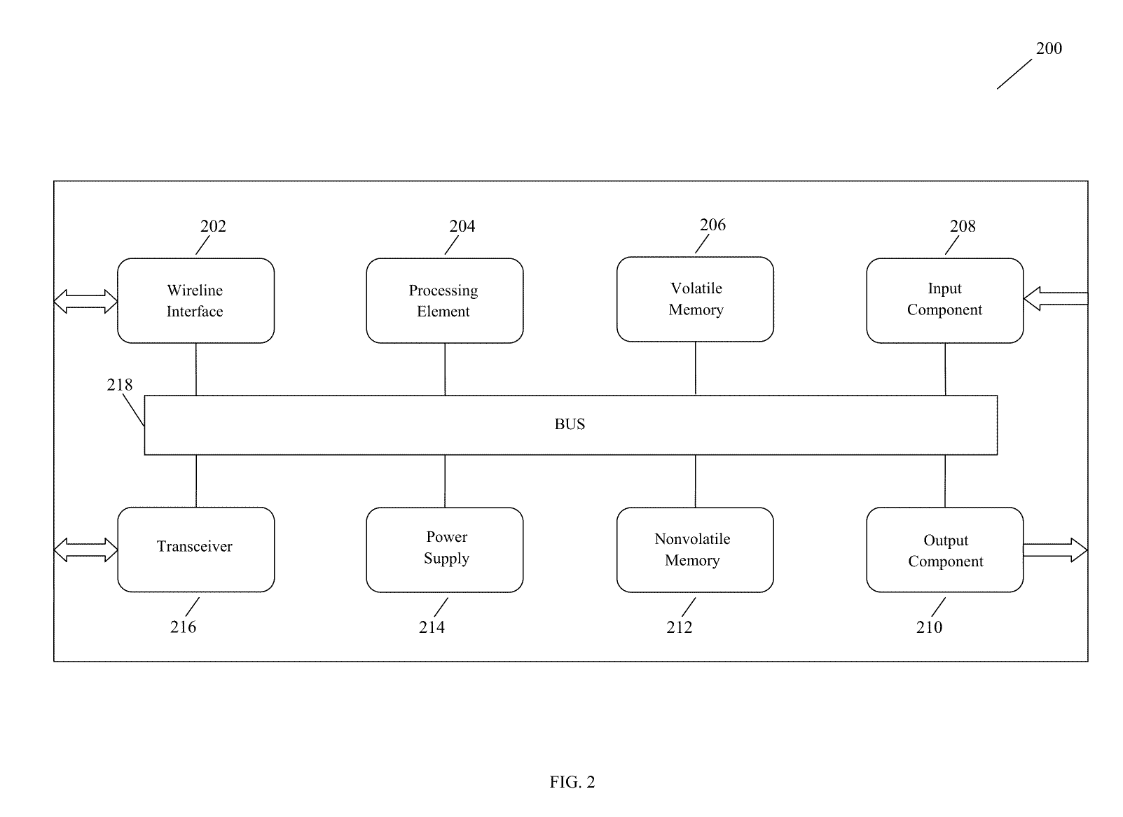

FIG. 2 shows a block diagram 200 illustrating some hardware components of an electronic device that includes a MOM. For a particular embodiment, the electronic device represented by the block diagram 200 is the electronic device 102. Specifically, the block diagram 200 shows a wireline interface 202, a processing element 204, volatile memory 206, an input component 208, an output component 210, nonvolatile memory 212, a power supply 214, and a transceiver 216 which are all operatively interconnected by a bus 218.

A limited number of device components 202, 204, 206, 208, 210, 212, 214, 216, and 218 are shown in the diagram 200 for ease of illustration. Other embodiments may include a lesser or greater number of components in an electronic device that includes a MOM. Moreover, other components needed for a commercial embodiment of a device that incorporates the components shown in the diagram 200 are omitted from FIG. 2 for clarity in describing the enclosed embodiments.

In general, the processing element 204 is configured with functionality in accordance with embodiments of the present disclosure as described in detail below with respect to the remaining figures. “Adapted,” “operative,” “capable” or “configured,” as used herein, means that the indicated components are implemented using one or more hardware elements, such as one or more operatively coupled processing cores, memory elements, and interfaces, which may or may not be programmed with software and/or firmware, as the means for the indicated components to implement their desired functionality. Such functionality is supported by the other hardware shown in FIG. 2, including the device components 202, 206, 208, 210, 212, 214, 216, and 218.

The processing element 204, for instance, includes arithmetic logic and control circuitry necessary to perform the digital processing, in whole or in part, for the MOM 104, with its included modules 106, 108, to schedule project meetings in accordance with described embodiments for the present teachings. For one embodiment, the processing element 204 represents a primary microprocessor, also referred to as a central processing unit (CPU), of the electronic device 102. For example, the processing element 204 can represent an application processor of a smartphone. In another embodiment, the processing element 204 is an ancillary processor, separate from the CPU, wherein the ancillary processor is dedicated to providing processing capability, in whole or in part, needed for the device components of the block diagram 200 to perform at least some of their intended functionality. For instance, where the electronic device 102 includes the PMM 110, the primary processor might perform processing associated with the MOM 104, and the ancillary processor might perform processing associated with the PMM 110.

The non-volatile memory 212 provides long-term storage for software used to program the processing element 204 to perform the functionality of the MOM 104, and in some instances the PMM 110, as described herein. The non-volatile memory 212 also provides long-term storage for data generated by the processing element 204. For particular embodiments, the electronic device 102 uses magnetic (e.g., hard drive) and/or solid state (e.g., flash memory) storage devices. The volatile memory 206, also referred to herein simply as “memory,” represents short-term storage, which is purged when the power supply 214 for the electronic device 102 is switched off and the electronic device 102 powers down. In one embodiment, the volatile memory 206 represents RAM having faster read and write times than the non-volatile memory 212.

The wireline interface 202 and the transceiver 216 allow the electronic device 102 to send and receive communications with other electronic devices. In particular, the electronic device 102 uses the wireline interface 202 to send and receive communications using a wired connection. For example, the wireline interface 202 includes a jack that accepts Category 5 or Category 6 Ethernet cables terminated in RJ45 connectors. In this way, the electronic device 102 is connected to the network switch 112, and in turn, the router 118, that enables the electronic device to operate as part of a LAN.

The electronic device 102 can use the transceiver 216 to send and receive wireless communications. In one embodiment, the transceiver 216 is a Wireless LAN (WLAN) transceiver that allows the electronic device 102 to access the Internet 120 using standards such as Wi-Fi. The WLAN transceiver 216 allows the electronic device 102 to send and receive radio signals to and from similarly equipped electronic devices using a wireless distribution method, such as a spread-spectrum or orthogonal frequency-division multiplexing (OFDM) method. For some embodiments, the WLAN transceiver 216 uses an IEEE 802.11 standard to communicate with other electronic devices in the 2.4, 3.6, 5, and 60 GHz frequency bands. In a particular embodiment, the WLAN transceiver 216 uses Wi-Fi interoperability standards as specified by the Wi-Fi Alliance to communicate with other Wi-Fi certified devices.

In another embodiment, the transceiver 216 is a cellular transceiver that enables the electronic device 102 to communicate with other electronic devices using one or more cellular networks. This includes, but is not limited to, the electronic device 102 using a cellular network to send and receive voice, text, and/or data to and from other devices with similar capabilities for sending and receiving such communications. Cellular networks can use any wireless technology that, for example, enables broadband and IP communications including, but not limited to, 3^{rd} Generation (3G) wireless technologies such as CDMA2000 and Universal Mobile Telecommunications System (UMTS) networks or 4^{th} Generation (4G) wireless networks such as LTE and WiMAX.

The input component 208 and the output component 210 allow for user interaction between the electronic device 102 and an individual, such as a programmer, a system administrator, or an operator. A programmer, for instance, might use the input 208 and output 210 components to program the processing element 204 to perform the functionality of the MOM 104. Additionally, a system administrator might use the input 208 and output 210 components to set parameters that control the operation of the MOM 104 within the confines of its programming. In one embodiment, the input component 208 includes a keyboard, and the output component 210 includes a monitor. In another embodiment, a touchscreen serves as both the input component 208 and the output component 210 of the electronic device 102.

The power supply 214 represents a power source that supplies electric power to the device components 202, 204, 206, 208, 210, 212, 216, 218, as needed, during the course of their normal operation. The power is supplied to meet the individual voltage and load requirements of the device components 202, 204, 206, 208, 210, 212, 216, 218 that draw electric current. For some embodiments, the power supply 214 is a wired power supply that provides direct current from alternating current using a full- or half-wave rectifier. For other embodiments, the power supply 214 is a battery that powers up and powers down a portable electronic device. For a particular embodiment, the battery 216 is a rechargeable power source. A rechargeable power source for a device is configured to be temporarily connected to another power source external to the device to restore a charge of the rechargeable power source when it is depleted or less than fully charged. In another embodiment, the battery is simply replaced when it no longer holds sufficient charge.

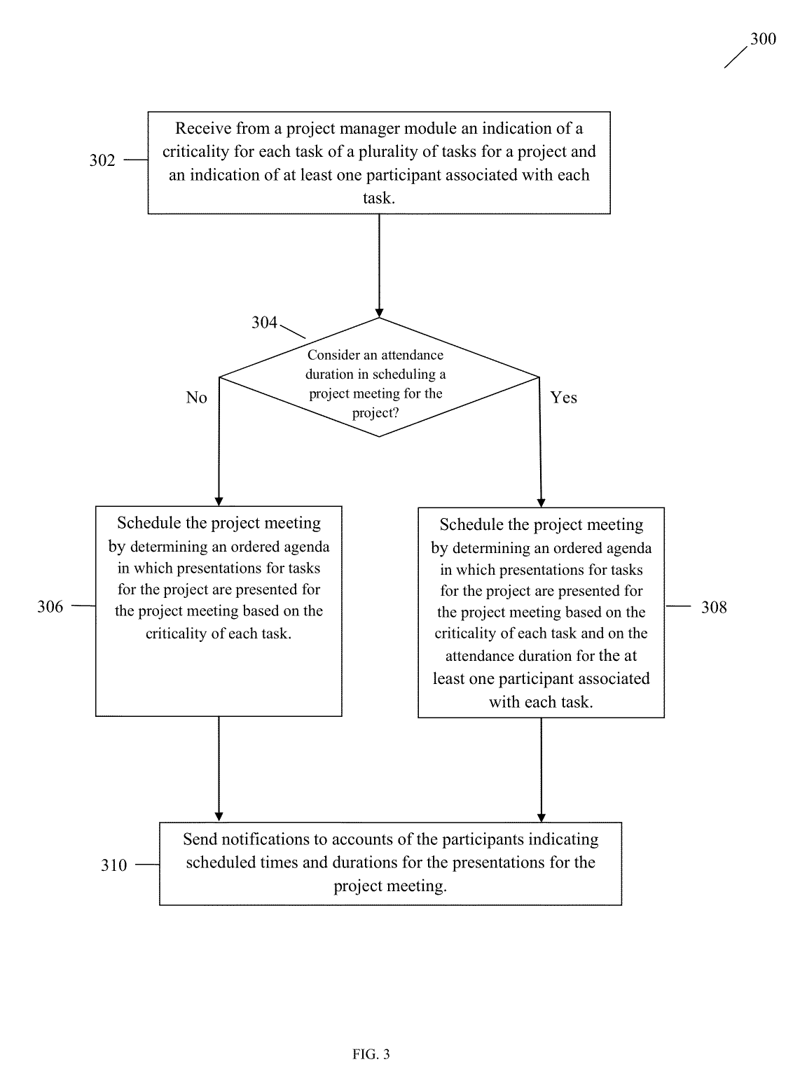

We turn now to a detailed description of the functionality of the MOM 104, its included modules 106, 108, and of the device components shown in FIG. 2, in accordance with the teachings herein and by reference to the remaining figures. FIG. 3 is a logical flow diagram illustrating a method 300 performed by the MOM 104 for scheduling project meetings. Specifically, the MOM 104 receives 302 an indication of a criticality for each task of a plurality of tasks for a project from the PMM 110. The MOM 104 also receives 302 from the PMM 110 an indication of at least one participant associated with each task who should be attending the project meeting. Referring momentarily to FIG. 4, the participants, the tasks, and the criticalities for the tasks are described in greater detail.

FIG. 4 shows a table 400 having nine rows 402, 404, 406, 408, 410, 412, 414, 416, 418 and twelve columns 420, 422, 424, 426, 428, 430, 432, 434, 436, 438, 440, 442. The first column 420 indicates eight tasks T₁, T₂, T₃, T₄, T₅, T₆, T₇, T₈, one for each of eight rows 404, 406, 408, 410, 412, 414, 416, 418, respectively. Each task represents a quantum of work and a portion of the project indicated at 302. For explanatory purposes, the project is taken to be the production of a concept car. In practice, projects are not limited to production. A non-exhaustive list of different categories for projects includes, for example, manufacturing, construction, marketing, product testing, research, and organizing venues. The production of the car is divided into the following eights tasks: marketing T₁, the interior T₂, the transmission T₃, the wiring T₄, the frame T₅, the body 1₆, the suspension T₇, and the engine T₈.

Associated with each task is at least one individual having accountability for completing the task. During the production of the car, regular product meetings, also simply referred to herein as “meetings,” are scheduled to keep everyone informed of the overall progress of the production of the car and to handle any issues that may arise. Every individual, however, need not attend the project meetings. Rather, one or more representatives for each task attend the meetings. Within the present description, individuals who attend a project meeting are referred to as “participants” of the meeting. A participant can physically attend a project meeting in person. A participant can also attend a project meeting remotely with the aid of one or more electronic devices. In a first example, all the participants of a project meeting are physically present in a conference room where the project meeting is taking place. In a second example, a remote participant uses a conference bridge to video conference with the other participants who are physically present in a conference room where a project meeting is taking place. In a third example, all participants of a project meeting are physically in different locations and each participant uses a conference bridge or other electronic means to communicate with the other participants.

The participants associated with each task present the progress of their task at the project meeting, listen to the presentations for other tasks in some cases, and deal with any issues that need to be addressed during the meeting. The participants may then report back to individuals working on the task who did not attend the project meeting. A presentation for a task, e.g., about the progress of completing the task, made by a participant at a project meeting for a project, as used herein, refers to verbal or written information the participant disseminates to other participants at the project meeting regarding the task for the project with which the participant is associated.

Ten participants for the eight tasks T₁, T₂, T₃, T₄, T₅, T₆, T₇, T₈ are indicated by the row 402. Each participant is designated by a different letter of the letters A, B, C, D, E, F, G, H, I, and J. The columns 422, 424, 426, 428, 430, 432, 434, 436, 438, and 440 indicate which task or tasks each participant is associated with. For example, participant C is working on the transmission T₃, and participant E is working on the interior T₂. In column 428, the number “1” appears twice for participant D, indicating that participant D is working on two tasks, the wiring T₄ and the body T₆.

The number “2” appearing in columns 432 and 438 indicates a dependency. Specifically, the number “2” with the subscript “T₅” in column 432 indicates the body T₆ is dependent upon the frame T₅ for completion. For this reason, participant F, who is not directly associated with the body T₆, should be in attendance when a presentation for the body T₆ is presented and/or discussed at the project meeting to offer relevant information regarding the frame T₅ that affects the body T₆. For an embodiment, the participants D and G might also want to be in attendance when a presentation for the frame T₅ is presented and/or discussed. In such case, a number “2” might be listed in columns 428 and 434 at row 412. Similarly, participant I, who is associated with the engine T₈, will need to brief participant C, who is associated with the transmission T₃, about progress on the engine T₈ upon which the transmission T₃ is dependent. Further levels of dependency to those represented in table 400 can be recognized in additional embodiments. For example, the wiring T₄ may be dependent upon the body T₆, which, in turn, may be dependent upon the frame T₅ for completion.

Column 442 specifies the criticalities of the tasks T₁, T₂, T₃, T₄, T₅, T₆, T₇, and T₈ at 404, 406, 408, 410, 412, 414, 416, and 418, respectively. As previously indicated, a criticality of a task is a quantitative measure that reflects a status of the task in terms of an importance or urgency in addressing the task relative to other tasks. A higher relative criticality can be indicative of an issue regarding a task that needs to be resolved in a project-meeting forum. The concept of criticality is further described by way of example.

In one example, individuals working on the engine T₈ are on schedule, but individuals working on the transmission T₃ are behind schedule. Therefore, the task T₃ has a higher criticality relative to the task T₈. At a project meeting, participants try to determine why the transmission T₃ is behind schedule and propose a remedy or a specific course of action in addressing the issue.

In a further example, the frame T₅ is additionally behind schedule, so the task T₅ also has a higher criticality relative to the task T₈. In one case, the criticality of task T₃ is greater than the criticality of task T₅ because the frame T₅ is only three days behind schedule, whereas the transmission T₃ is five days behind schedule. In another case, it becomes more important to address the issue of the frame T₅ being behind schedule even though the transmission T₃ is further behind schedule by two days. This is because the individuals working on the body T₆ are dependent upon the frame T₅ being on schedule. If the frame T₅ is behind schedule at a critical time, individuals working on the body T₆ might be rendered idle.

In another example, individuals working on the wiring T₄ have discovered that an ignition switch is susceptible to vibration and has the potential of shutting off the engine while the car is being driven on rough pavement. While the task T₄ is not behind schedule, the potential safety concern associated with the problematic ignition switch needs to be addressed at a group meeting. Therefore, the criticality associated with the wiring T₄ is elevated upon discovery of the problem.

In an additional example, a supply chain issue elevates the criticality for a task. Fourteen-gauge wire is available from a supplier but sixteen-gauge wire is currently unavailable. One solution proposed and discussed at a project meeting is to order sixteen-gauge wire from a different supplier. Another solution proposed and discussed is to reorganize the task T₄ by proceeding with the fourteen-gauge wiring and completing the sixteen-gauge wiring at a later time when the sixteen-gauge wire becomes available. In a particular case, the order of work done for another task that is dependent upon the wiring T₄ is also reorganized so that work may proceed for both tasks without down time.

A criticality for a task can also be based on a severity of impact resulting from an issue associated with a task. For instance, cost overruns accumulate daily for a facility and workers retained under contract if those workers cannot begin work until a first task is completed. By contrast, no contract workers, or a lesser number of contract workers might be delayed if a second task is behind schedule. In this case, the first task has a higher criticality than the second task, even if both tasks are behind schedule by the same amount.

For one embodiment, a criticality for a task is entered into an electronic device by one or more individuals associated with a task. For example, a worksite electronic device (not shown) is located in a room where the transmission T₃ is being assembled. The worksite electronic device is networked to the electronic device 114, which houses the PMM 110. Every afternoon, at the close of business, an appointed individual working on the transmission T₃ enters into the worksite electronic device an updated criticality for the transmission T₃. The appointed individual chooses a lowest criticality when work is on schedule and there are no complications. If a complication arises, the appointed individual chooses a higher criticality in accordance with the nature of the complication. The criticality the appointed individual chooses is then messaged to the electronic device 114 and the PMM 110.

In another embodiment, the PMM 110 uses a programmed algorithm to calculate a criticality for the transmission T3 from information the appointed individual, or another electronic device, enters into the worksite electronic device. For example, the appointed individual inputs status data to the worksite electronic device. That status data is then communicated over a LAN to the electronic device 114. The PMM 110 then calculates the updated criticality for the transmission T₃ based on the status data. The status data the appointed individual provides might also include responses to queries. For instance, if a catalog system indicates a needed part is unavailable, the worksite electronic device prompts the appointed individual or the catalog system to indicate when the part will become available. It might be the case that the part is delayed by shipping, backordered, or permanently unavailable from a given vendor.

The criticality for the transmission T₃ indicted in column 442 is red. For the immediate example, three levels of criticality are possible, red, yellow, and green, with red being the highest criticality and green being the lowest criticality. Green indicates, for example, that a task is on schedule and without complications. Yellow indicates that a task is behind schedule, but that the task can be brought back on schedule without intervention and before any dependent tasks are affected. Red indicates a solution is needed to bring a task back on schedule, to an extent possible, and/or to minimize the task's impact on dependent tasks. At the project meeting, a participant associated with the transmission T₃ presents issues underlying the task's status. Participants at the project meeting can then propose and discuss potential solutions or courses of action before a particular solution or course of action is decided upon and implemented.

As shown in table 400, a criticality for a task can assume one of three discrete values. In different embodiments, tasks for a project can assume any number of values. For example, a criticality for a task of one project can assume any one of ten values. In another embodiment, the criticality for a task represents a continuous, rather than a discrete, variable. In an additional embodiment, the criticalities of tasks take on relative values so that the tasks may be identified in ascending or descending order of criticality. For example, a criticality for a second task is greater than a criticality for a first task and less than a criticality for a third task.

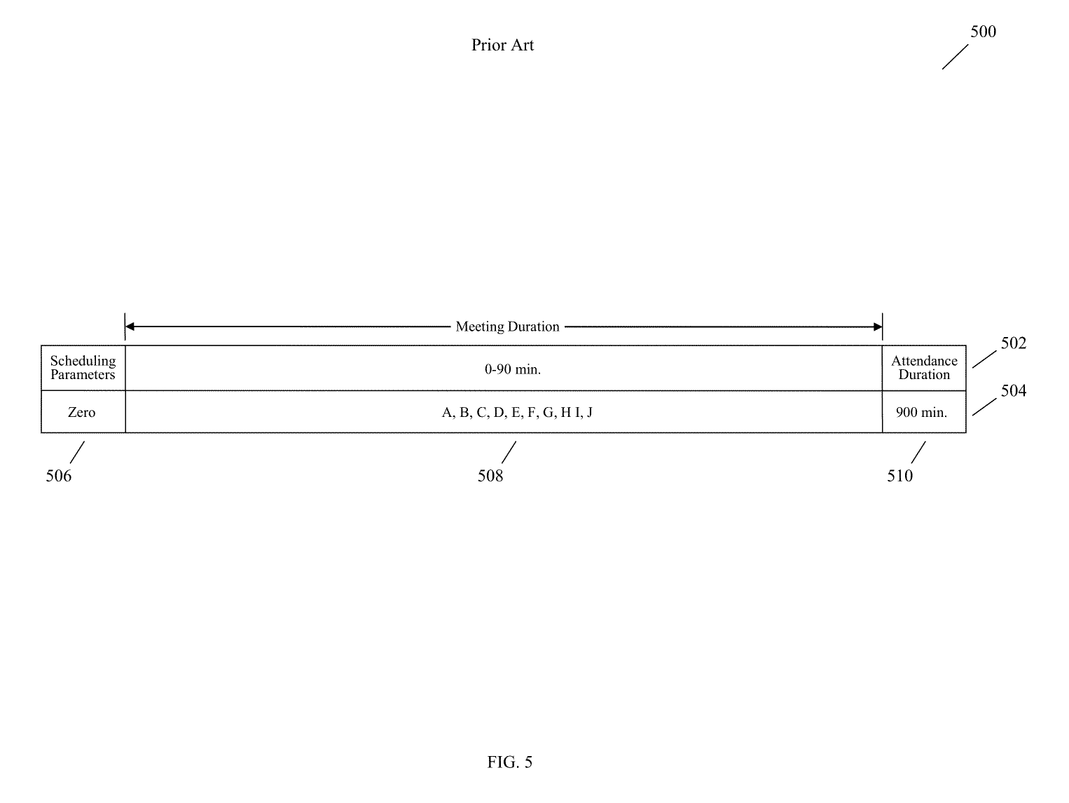

Returning to FIG. 3, the MOM 104 proceeds to schedule a project meeting for the project after the MOM 104 has received 302 the indication of the criticalities for the tasks for the project. The MOM 104, using the SM 106, may schedule the project meeting based on a first scheduling parameter, and in some implementations, also based on a second scheduling parameter. The first scheduling parameter can represent the criticalities for the tasks of the project. The second scheduling parameter can represent an attendance duration for one or more participants of the project meeting. Before describing the scheduling of the project meeting in accordance with the present teachings, the scheduling of a project meeting in accordance with prior art is described briefly with reference to FIG. 5.

FIG. 5 shows a table 500 having two rows 502, 504, and three columns, 506, 508, 510. The column 506 indicates that no scheduling parameters were used in scheduling the project meeting represented by the table 500. The second column 508 indicates that all ten participants indicated in the table 400 attend the entire duration of the meeting, which is 90 minutes. When each of the ten participants is in attendance for the entire 90-minute meeting, the total attendance duration for the meeting is 900 minutes, as indicated by the column 510. Some participants are actively involved in only a portion of the meeting, nevertheless, calendars for those participants show their status as unavailable for the entire 90-minute duration of the meeting.

Returning to FIG. 3, if the MOM 104 considers 304 the first but not the second scheduling parameter in scheduling the project meeting in accordance with the present teachings, then the MOM 104 schedules 306 the project meeting by determining an ordered agenda in which presentations for tasks for the project are presented at the project meeting based on the criticality of each task but not on an attendance duration of at least one participant of the project meeting. If the MOM 104 considers 304 both the first and the second scheduling parameters in scheduling the project meeting, then the MOM 104 schedules 308 the project meeting by determining the ordered agenda for the meeting based on both the criticality of each task and an attendance duration of at least one participant of the project meeting.

When the project meeting is scheduled, the MOM 104 sends 310 notifications to the accounts of the participants of the project meeting. Each participant receives a notification informing the participant of the time when his or her presentation begins and of a duration of time for the presentation, also referred to herein simply as a “duration,” allotted for the presentation. If a participant is scheduled to present multiple presentations, then the notification the participant receives indicates times and durations for the multiple presentations. For an embodiment, the wireline interface 202 and/or the transceiver 216 communicatively connected to the electronic device 102 and communicatively coupled to the MOM 104 is configured to send the one or more notifications to the accounts of the one or more participants.

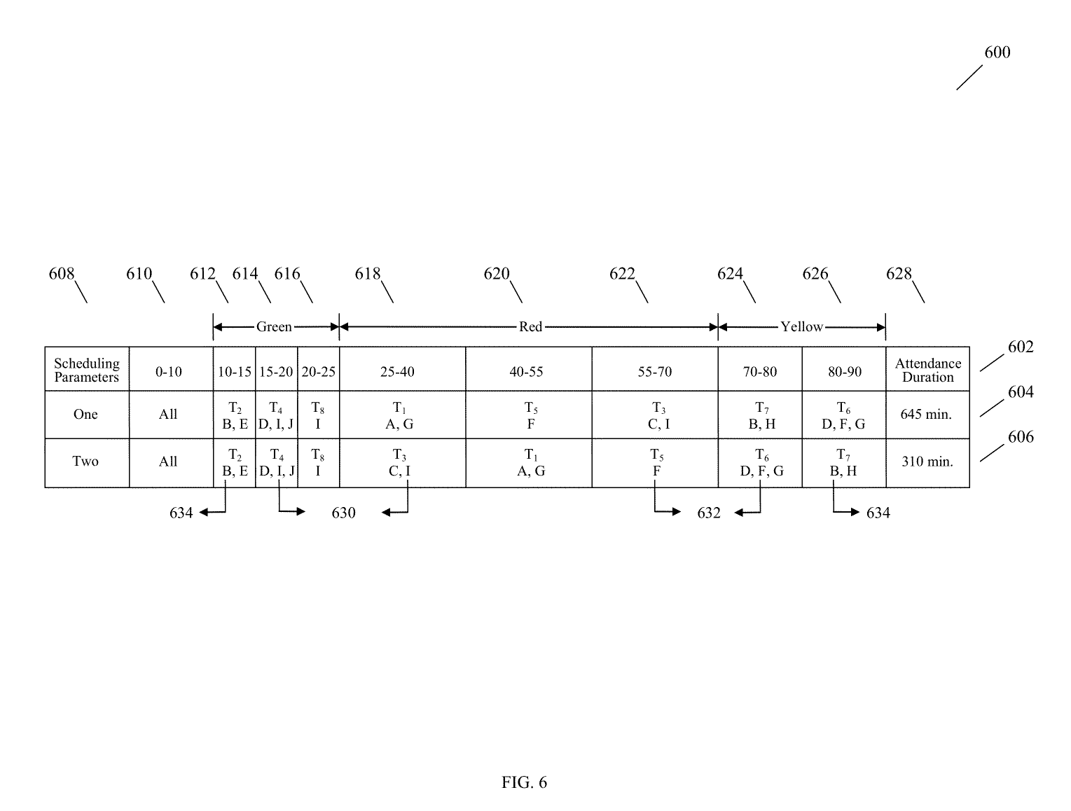

FIG. 6 shows a table 600, having three rows 602, 604, 606 and eleven columns 608, 610, 612, 614, 616, 618, 620, 622, 624, 626, 628, which displays two ordered agendas for the project meeting for the ten participants indicated in the table 400. A first ordered agenda, which is based on one scheduling parameter, as indicated in the column 608, namely the criticality of the tasks, is displayed in the row 604. Row 606 displays a second ordered agenda for the project meeting, which is based on two scheduling parameters, as indicated in the column 608, namely both the criticality of the tasks and ordering the participants. When determining the ordered agenda is further based on ordering a plurality of participants, the MOM 104 receives an indication of the plurality of participants associated with the plurality of tasks from the PMM 110. The PMM 110 sends the indication to the MOM 104, for example, over the LAN connecting the electronic devices 102 and 114.

For one embodiment, scheduling the project meeting includes the MOM 104 allotting a duration for a presentation for a task based on the criticality of the task. For instance, a greater duration might be allotted for a task having a red criticality than for a task having a green criticality. It takes additional time to propose, discuss, and agree upon a solution or course of action to bring a task having a red criticality back on schedule as compared to the time needed to just make a presentation for a task having a green criticality that is currently on schedule. In the table 600, for instance, the MOM 104 gives each presentation for a task having a red criticality a duration of 15 minutes, whereas the MOM 104 gives each presentation for a task having a green criticality a duration of 5 minutes. Presentations for tasks having a yellow criticality are given a 10-minute duration.

In another embodiment, the MOM 104 scheduling the project meeting includes the MOM 104 receiving from the PMM 110 a presentation type for a task and allotting, based on the presentation type, a duration for a presentation for the task. A presentation type, as used herein, refers to a nature of a presentation being given for a task. Certain types of presentations might require more time than other types of presentations. A performance presentation, which deals with the capabilities of an item of manufacture, for example, might take longer than a materials presentation in which the materials used to manufacture the item are disclosed. Similarly, a presentation that provides an overview for an entire task might take longer, and is therefore allotted a longer duration, than a presentation that provides an overview of only a portion of the task. It might be the case that since a last project meeting, work for the engine T₈ was only conducted on pistons of the engine T₈. Therefore, the MOM 104 allots less time to presentation for the engine T₈ for the project meeting than was allotted for the presentation during the last project meeting when the entire engine block was discussed.

The 90-minute project meeting is divided into nine time periods indicated in the row 602 by the columns 610, 612, 614, 616, 618, 620, 622, 624, and 626. For both ordered agendas, the 0-to-10-minute time period is attended by all the participants of the meeting. During this time period, for example, general business relating to the project as a whole is addressed. For each of the remaining eight time periods, a presentation for a task is made. For instance, for the first agenda, during the 40-to-55-minute time period, participant F makes a presentation for the task T₅. For the second agenda, participant A and participant G, who are both associated with the task T₁, make a presentation for the task T₁ during the 40-to-55-minute time period.

Both the first and the second ordered agendas are based on the criticalities for the tasks. For an embodiment, determining the ordered agenda for the project meeting includes scheduling to the beginning of the project meeting a presentation for a task having a lowest criticality. The table 600 displays all three tasks T₂, T₄, T₈ having the lowest criticality, namely the green criticality, grouped together at the beginning of the meeting during the second, third, and fourth time periods, as indicated in columns 612, 614, and 616. Similarly, all three tasks T₁, T₃, T₅ having the red criticality are grouped together at the middle of the meeting during the fifth, sixth, and seventh time periods, as indicated in columns 618, 620, and 622. Additionally, both tasks T₆, T₇ having the yellow criticality are grouped together during the eighth and ninth time periods at the end of the meeting, as indicated in columns 624 and 626. Participants associated with tasks having a green criticality, who presumably have been working diligently to stay on schedule, are free to leave the meeting when they are through with their presentations, provided they are not also associated with other tasks having a yellow or red criticality.

In a first example, participant E, who is only associated with the task T₂, arrives with the other participants at the beginning of the meeting to attend the initial 10-minute project overview indicated in column 610. Immediately thereafter, participant E gives his presentation for the task T₂ in the 10-to-15-minute time period. After the presentation, participant E is free to leave the project meeting. In a second example, participant I for the first ordered agenda gives her presentation for the task T₄ during the 15-to-20-minute time period and gives her presentation for the task T₈ during the 20-to-25-minute time period. Participant I, however, should also be present for the presentation for the task T₃ during the 55-to-70-minute time period. This is because the task T₃ is dependent on the task T₈ for completion. After the 55-to-70-minute time period, participant I is free to leave the meeting. Summed up, all the minutes each participant is at the meeting for the first ordered agenda is 645 minutes, as indicated in column 628, which is 255 minutes less than the 900-minute attendance duration that results from each participant attending the full meeting.

The second ordered agenda indicated in row 606 further optimizes the first ordered agenda indicated in row 604 in terms of attendance duration based on ordering presentations for individual or multiple participants. For some embodiments, determining the ordered agenda for the project meeting includes scheduling presentations for a set of tasks associated with a participant to reduce an attendance duration for the participant at the project meeting. In general, for different embodiments, a set may be limited to having only a single element or it may include multiple elements. For one embodiment, a participant is associated with multiple tasks, and the MOM 104 schedules the presentations for the multiple tasks to minimize one or more time intervals between the tasks. This is done to minimize the amount of time the participant needs to be at the meeting. For the first ordered agenda, participant I needs to wait 30 minutes after making her presentation for the task T₈ during the 20-to-25-minute time period before she can make her presentation for the task T₃ during the 55-to-70-minute time period.

For the second ordered agenda, the MOM 104 schedules the presentation for the task T₃ during the fifth time period, immediately after the presentation for the task T₈. In this way, all three presentations for participant I are contiguous during the third, fourth, and fifth time periods, as indicated at 630, and the presentations for the tasks T₁, T₃, T₅ having the red criticality remain contiguous during the fifth, sixth, and seventh time periods. After the presentation for the task T₃ during the 25-to-40-minute time period is concluded, participant I can leave the meeting. An individual attendance duration for participant I is reduced to 40 minutes spent at the project meeting.

For the first agenda, the presentations for the tasks T₅ and T₆, with which participant F is associated, are given during the sixth and ninth time periods, respectively. Participant F has only 25 minutes of free time between these two presentations, which might not be enough time to leave the meeting. For the second agenda, the presentation for the task T₅ is scheduled during seventh time period, and the presentation for the task T₆ is scheduled during the eighth time period. The two presentations for participant F are made contiguous, as indicated at 632, while the presentations for red tasks and the presentations for yellow tasks remain contiguous. Participant F is present for the first 10 minutes of the meeting during which time general business intended for all participants is presented. Thereafter, participant F is free for 45 minutes until the seventh time period. This is more likely enough time for participant F to leave the meeting and conduct other business before returning. After the presentation of the task T₆ during the eighth time period, participant F is again free to leave the meeting, this time 10 minutes before the meeting ends.

For another embodiment, a participant is associated with multiple tasks, and the MOM 104 schedules the presentations for the multiple tasks to maximize one or more time intervals between the tasks. As presentations are grouped together for some participants, it becomes increasingly more difficult to schedule additional groupings for other participants without disturbing existing groupings. In this instance, presentations for one or more of the other participants are spread apart, allowing a larger time interval between presentations for an individual to leave and then return to the meeting. With presentations for participant I and participant F grouped together in contiguous blocks 630, 632, the MOM 104 schedules the presentation for the task T₇ in the ninth time period for the second ordered agenda rather than in the eight time period as it did for the first ordered agenda. By so doing, the presentations for participant B are separated by the longest possible time interval 634. Participant B has 65 minutes between the presentation for the task T₂ and the presentation for the task T₇ in which to leave the project meeting and return. Assuming that 30 minutes or more is sufficient time for a participant to leave the meeting and conduct other business before returning, the total attendance duration of the second ordered agenda for all the participants is 310 minutes, as indicated in column 628.

For an embodiment, the MOM 104 uses the ADTM 108 to determine an ordered agenda, from a plurality of possible ordered agendas, that reduces or minimizes an attendance duration for a participant or multiple participants. For each permutation of an ordered agenda, the ADTM 108 calculates one or more attendance durations for one or more participants. The ADTM 108 then uses a comparative algorithm to determine which of the tested ordered agendas provides an attendance duration that falls within a set of specified parameters. Considering the first and second ordered agendas as different permutations, the ADTM 108 determines the second ordered agenda has a lower collective attendance duration than the first ordered agenda. Based on this, the MOM 104 eliminates the first ordered agenda as an ordered agenda to use in scheduling the project meeting.

The MOM 104 might need an ordered agenda that minimizes an individual attendance duration for a single participant, that minimizes a collective attendance duration for a set of participants, or that minimizes an attendance duration for all participants. Alternatively, an ordered agenda might be sought that restricts the presentations of a participant to a particular portion of the project meeting based on that participant's availability while also minimizing an attendance duration for other participants.

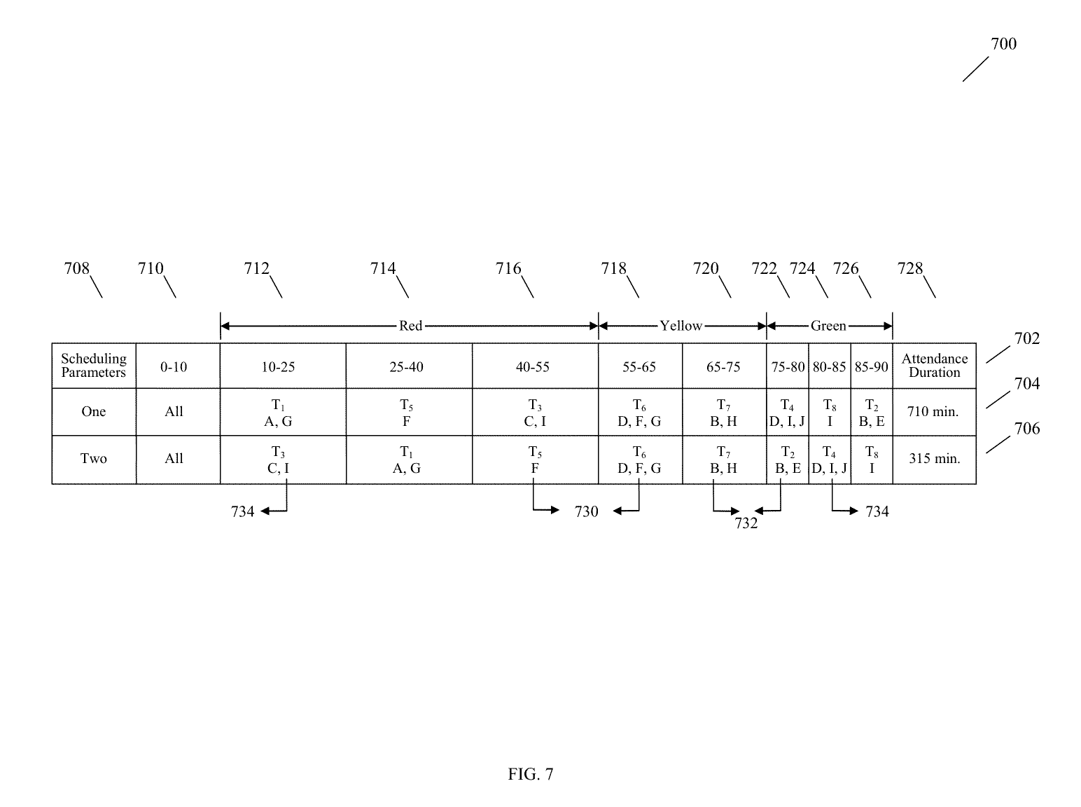

In some embodiments, the MOM 104 schedules presentations for tasks having a highest criticality to the beginning of a project meeting in determining an ordered agenda. For further embodiments, the MOM 104 also schedules presentations for tasks having a lowest criticality at the end of the project meeting. One such embodiment is shown in FIG. 7. In particular, FIG. 7 shows a table 700 that displays a third and a fourth ordered agenda, which are different from the first and second ordered agendas displayed by table 600, for the project meeting of the participants indicated in the table 400. Table 700 is laid out identically to the table 600 with three rows 702, 704, 706 and eleven columns 708, 710, 712, 714, 716, 718, 720, 722, 724, 726, 728.

The MOM 104 schedules the presentations for the red tasks having the highest criticality first because resolving critical issues associated with the red tasks during the 90-minute project meeting is of greatest importance. The MOM 104 schedules the presentations for the yellow tasks next because the yellow tasks are also associated with issues that should be addressed by participants at the project meeting. The presentations for the green tasks are scheduled to the end of the project meeting because they are of least importance. No issues that need to be immediately addressed are associated with the green tasks. Should the project meeting be cut short or a time period allotted for the project meeting expire before all scheduled presentations are given, the presentations for the green tasks can be postponed or skipped with the least consequence. Some presentations for green tasks, for example, can be rescheduled or dropped if dealing with a task having a higher criticality takes longer than the duration of the time period for which the task having the higher criticality was scheduled for.

The MOM 104 determines the third ordered agenda displayed by the row 704 based on one scheduling parameter, namely the criticality of the tasks. Presentations for tasks having like criticality are grouped together as shown. In determining the fourth ordered agenda of row 706, the MOM 104 groups the presentations for the tasks based on criticalities of the tasks and also orders the presentations for the tasks based on the participants associated with each task. For example, the MOM 104 groups presentations together for participant F in a contiguous time block 730, and groups presentations together for participant B in a contiguous time block 732. Whereas, presentations for participant I are separated by a greatest possible time interval 734 of 55 minutes.

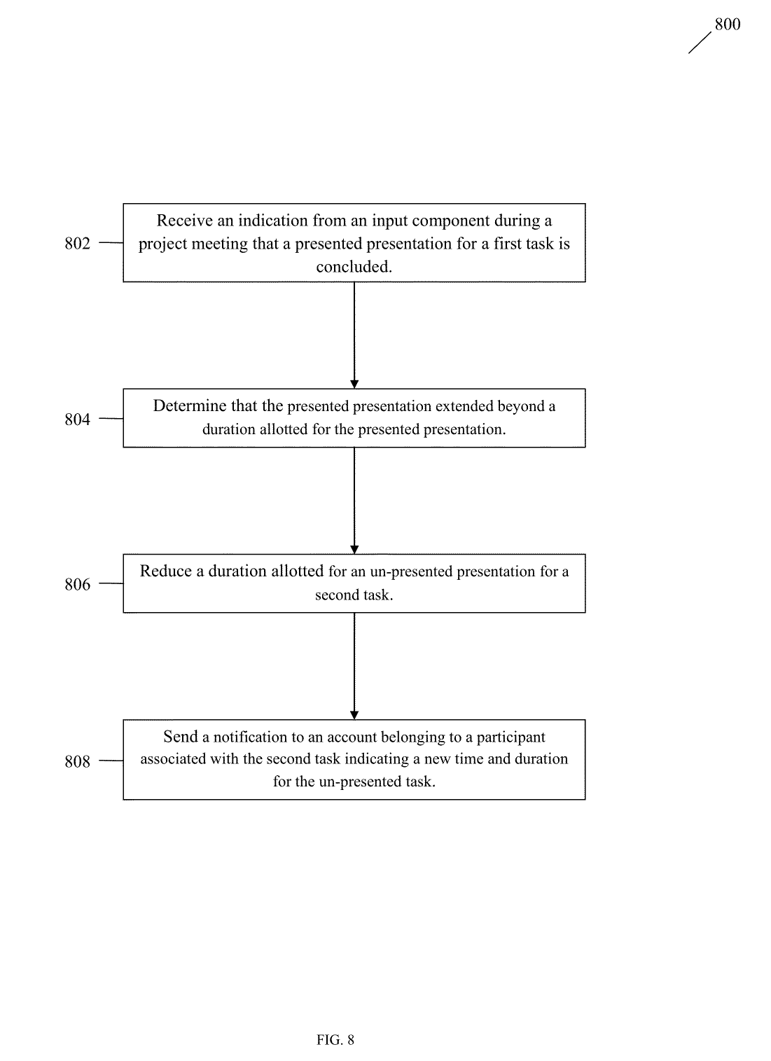

FIG. 8 shows a logical flow diagram 800 for a method by which the MOM 104 reduces an amount of time allotted for a presentation that has yet to be presented when a presentation that was presented extended beyond a time duration allotted for the presented presentation. The MOM 104 receives 802 an indication from the input component 208 during the project meeting that a presentation for a task is concluded. It might be the case, for example, that a participant keeping minutes for the meeting using a laptop or other electronic device 102 that includes the MOM 104 provides input into the input component 208 when each presentation is concluded. In another instance, a participant making a presentation provides input to the electronic device 102 that includes the MOM 104, or to an electronic device that is communicatively coupled to the electronic device 102 that includes the MOM 104, wherein the input indicates that the presentation made by the participant is concluded. From the input, the MOM 104 determines 804 that the presented presentation extended beyond a duration allotted for the presented presentation. This is done, for example, by referencing a clock and comparing the time against the ordered agenda for the project meeting when the indication that the presented presentation has concluded is received.

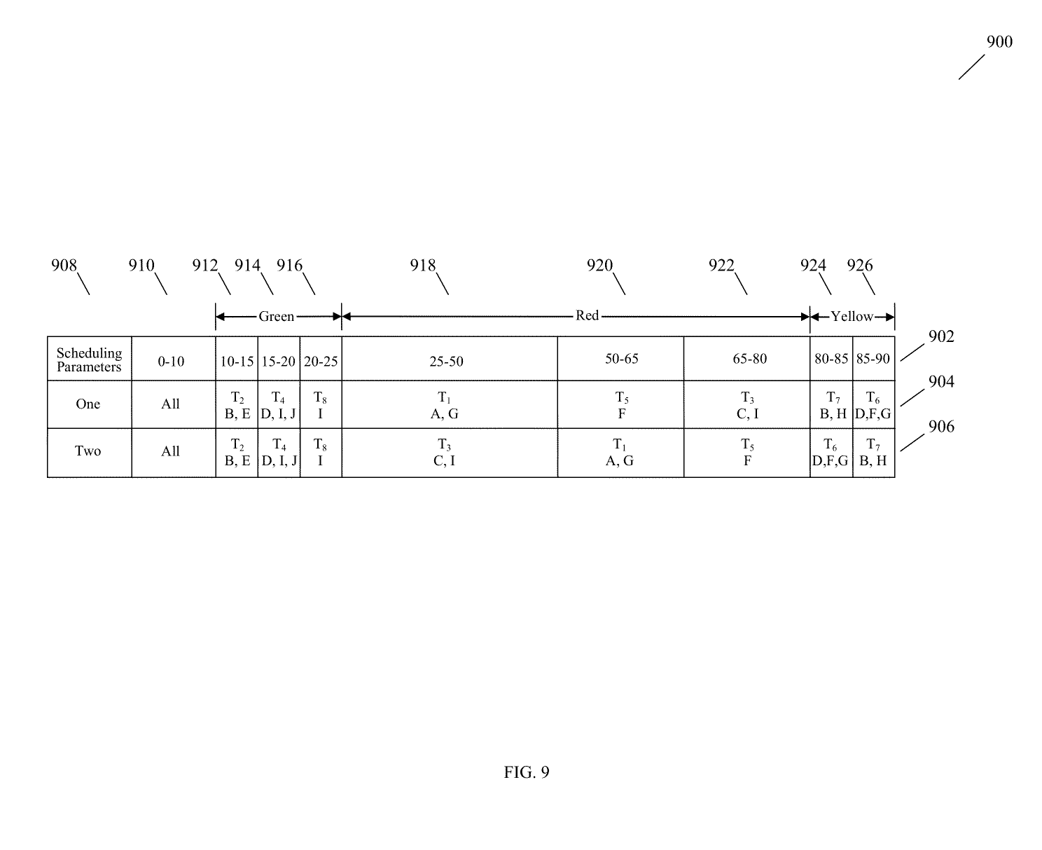

When the MOM 104 determines 804 that the presented presentation extended beyond the duration allotted for the presented presentation, the MOM 104 responsively reduces 806 an amount of time allotted for an un-presented presentation that was scheduled after the presented presentation. For some embodiments, reducing an amount of time allotted for an un-presented presentation includes reducing an amount of time allotted for more than one un-presented presentation to gain back the time of the overage. One such embodiment is illustrated in FIG. 9.

FIG. 9 shows a table 900 that displays the same ordered agendas displayed in the table 600, but with a reduction in the time allotted for two presentations. Rows 902, 904, and 906 of table 900 represent the rows 602, 604, and 606 of table 600, respectively. Similarly, columns 908, 910, 912, 914, 916, 918, 920, 922, 924, and 926 of table 900 represent the columns 608, 610, 612, 614, 616, 618, 620, 622, 624, and 626 of table 600, respectively. Column 918, however, has a width of 25 minutes, whereas column 618 of the table 600 has a width of 15 minutes. As indicated in the table 600, all the red tasks T₁, T₃, T₅ have an allotted duration of 15 minutes, and all the yellow tasks T₆, T₇ have an allotted duration of 10 minutes.

Column 918 indicates two separate scenarios, one for each ordered agenda. For the first ordered agenda, column 918 indicates that the presentation for the red task T₁ took 10 minutes longer than the 15-minute duration allotted for the fourth presentation of the project meeting. For the second ordered agenda, column 918 indicates that the presentation for the red task T₃ took 10 minutes longer than the 15-minute duration allotted for the fourth presentation of the project meeting. In each case, the MOM 104 gains the 10 minutes back by reducing 806 the duration allotted for each of the two yellow tasks T₆, T₇ from the 10 minutes indicated in the table 600 to 5 minutes.

After reducing 806 the amount of time allotted for an un-presented presentation in response to a presented presentation extending beyond its allotted duration, the MOM 104 sends 808 a notification to an account belonging to a participant associated with the un-presented presentation. The notification indicates a new scheduled time for the un-presented presentation and/or a new scheduled duration for the un-presented presentation. In the event that the allotted times of multiple un-presented presentations are reduced, the MOM 104 sends notifications to the accounts of multiple participants. For the first ordered agenda, for example, the MOM 104 sends a notification to an account of one or both of the participants B and H indicating that the new scheduled time for the presentation for the task T₇ is 80 minutes into the project meeting. The notification might also indicate that the new allotted duration for the presentation is five minutes rather than 10 minutes. One or more of the participants D, F, and G also receives a notification indicating that the presentation associated with the task T₆ is now scheduled to begin 85 minutes into the project meeting, and for an embodiment, that the presentation now has a duration of only five minutes.

For other embodiments, if a presentation extends beyond a duration allotted for the presentation, then the MOM 104 responsively reschedules an un-presented presentation to another project meeting. When presentations for tasks having the lowest criticality are scheduled to the end of a project meeting, for example, at least one such presentation may be rescheduled to a future project meeting. This is because tasks having the lowest criticality more likely have no issues that need addressing at the project meeting.

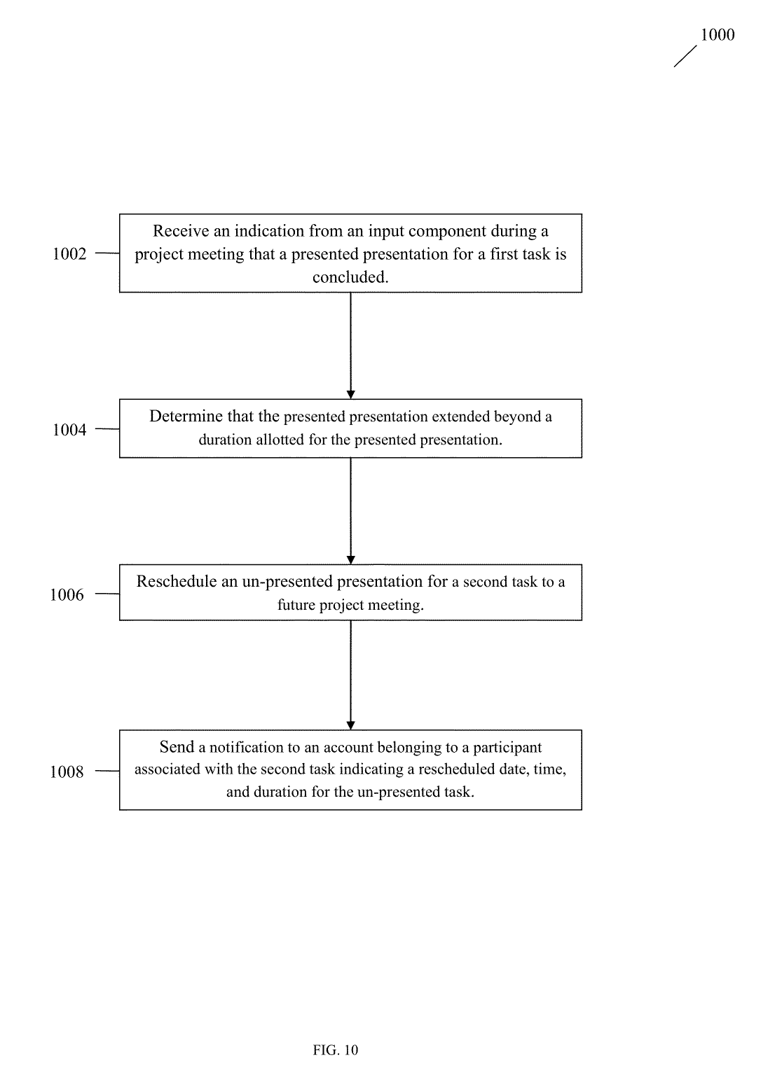

FIG. 10 shows a logical flow diagram illustrating a method 1000 for rescheduling an un-presented presentation to a future project meeting when a presented presentation ran longer than the duration allotted for the presented presentation. In particular, the method 1000 shows the MOM 104 receiving 1002 an indication during a project meeting that a presentation for a task is concluded. For one embodiment, the indication originates from an input component 208 of the electronic device 102 that includes the MOM 104. In another embodiment, the indication originates from an input component of another electronic device that is communicatively coupled to the electronic device 104 that includes the MOM 104.

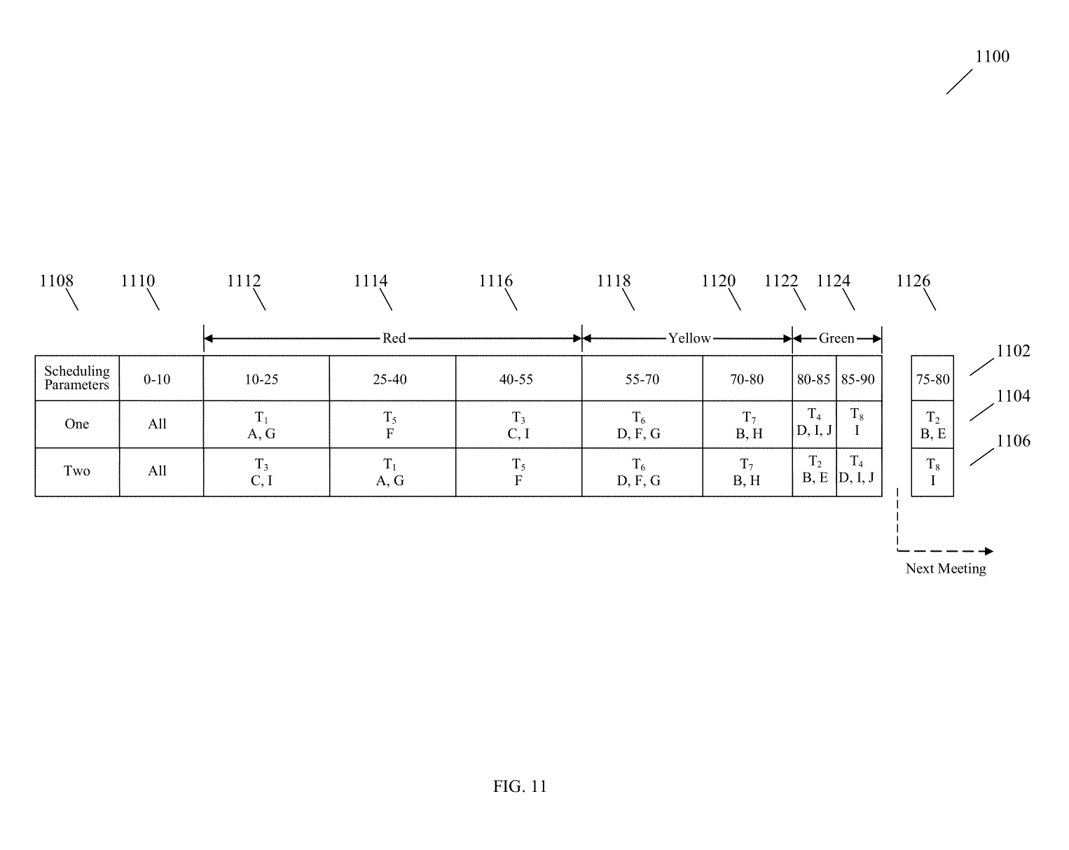

From a time at which the indication is received 1002, for instance, the MOM 104 determines 1004 that the presented presentation extended beyond a duration allotted for the presented presentation. The MOM 104 responsively reschedules 1006 an un-presented presentation to a future project meeting. The MOM 104 also sends 1008 a notification to an account belonging to a participant associated with a task for which the un-presented presentation is to be given. The notification indicates a rescheduled time for the un-presented presentation. If the future project meeting is scheduled for a different date, then the notification also indicates the rescheduled date for the un-presented presentation. When multiple un-presented presentations are rescheduled for different tasks associated with different participants, the MOM 104 sends 1008 notifications to each of multiple accounts. Rescheduling an un-presented presentation to a future meeting when a presented presentation exceeds its allotted duration is described in greater detail with reference to FIG. 11.

FIG. 11 shows a table 1100 that displays the same ordered agendas displayed in the table 700, for which tasks having the green criticality are scheduled to the end of the project meeting. Rows 1102, 1104, and 1106 of table 1100 represent the rows 702, 704, and 706 of table 700, respectively. Similarly, columns 1108, 1110, 1112, 1114, 1116, 1118, 1120, 1122, 1124, and 1126 of table 1100 represent the columns 708, 710, 712, 714, 716, 718, 720, 722, 724, and 726 of table 700, respectively. Column 1118, however, has a width of 15 minutes, whereas column 718 of table 700 has a width of 10 minutes. This represents that the presentation of the yellow task T₆ extended 5 minutes over the 10-minute duration scheduled for the task T₆. To gain back the 5 minutes lost, the MOM 104 reschedules the presentation for the task T₂ for the third ordered agenda of row 1104, or the presentation for the task T₈ for the fourth ordered agenda of row 1106, to a future project meeting. For the embodiment shown, the presentation of the task T2 or T8 is rescheduled to occur during a 75-to-80-minute time period of the future project meeting. Where regularly scheduled project meeting are held weekly, for instance, the future project meeting would occur in one week.

For one embodiment, the MOM 104 selects an un-presented presentation to reschedule based on both an amount of time a presented presentation extended beyond a duration allotted for the presented presentation and based on a duration allotted for the un-presented presentation. If, for example, the durations allotted for the green tasks T₂, T₄, and T₈ were 8 minutes, 5 minutes, and 12 minutes, respectively, then the MOM 104 would reschedule the presentation for the task T₄ to the next project meeting. Other factors being equal, the MOM 104 selects the presentation to reschedule based on that presentation having an allotted duration that is closest to the time by which the presented presentation extended beyond its allotted duration. In different embodiments, other factors come into play. One such factor includes queue starvation where, for instance, a lower-priority presentation for a green task is rescheduled multiple times due to higher-priority presentations for yellow and red tasks running over their allotted durations in successive project meetings.

To prevent queue starvation, a particular embodiment reassigns a yellow criticality to a task having a green criticality when a presentation for the task is first rescheduled to a future project meeting. This prevents the presentation from being rescheduled again if a presentation runs over its allotted duration during the future project meeting. Continuing with the above example, the MOM 104 reschedules the 8-minute presentation for the task T₂ instead of the 5-minute presentation for the task T₄ to the next project meeting because the presentation for the task T₄, which now has a yellow criticality, has already been rescheduled. In another embodiment, the task T₄ is not reassigned a yellow criticality, however, the MOM 104 still reschedules the 8-minute presentation for the task T₂ instead of the 5-minute presentation for the task T₄ to the next project meeting based on the presentation for the task T₄ having already been rescheduled.

For some embodiments, multiple un-presented presentations are rescheduled to a future project meeting where the combined durations allotted for the multiple un-presented presentations comes closest to the time by which the presented presentation extended beyond its allotted duration. If, for example, the MOM 104 needed to gain back 17 minutes, the MOM 104 might reschedule both the un-presented presentation for the task T₄ and the un-presented presentation for the task T₈.

In other embodiments, the SM 106 included within the MOM 104 is configured to receive availability information from the PMM 110 indicating the availability of one or more of the participants of the project meeting. A participant, for example, might input into the PMM 110 calendar dates on which the participant is vacationing or otherwise unavailable. For a particular embodiment, the PMM 110 is communicatively coupled to an electronic device the participant uses to run calendar software. The PMM 110 receives from the electronic device running the calendar software the availability information for the participant and communicates the availability information to the SM 106. The SM 106 then selects the un-presented presentation to reschedule based on the availability information. For the fourth ordered agenda of row 1106, for example, the SM 106 selects the un-presented presentation for the task T₂ to reschedule a future project meeting next week based on the fact that availability information the SM 106 receives indicates that participant I associated with tasks T₄ and T₈ is unavailable next week.

In the foregoing specification, specific embodiments have been described. However, one of ordinary skill in the art appreciates that various modifications and changes can be made without departing from the scope of the disclosure as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has,” “having,” “includes,” “including,” “contains,” “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a,” “has . . . a,” “includes . . . a,” or “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially,” “essentially,” “approximately,” “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

We claim:

1. A method performed by a meeting organizer module of an electronic computing device for scheduling project meetings, the method comprising:
receiving, from a project manager module, a first criticality for a first task and a second criticality for a second task of a plurality of tasks for a project; and
scheduling a project meeting for the project based on the first criticality and the second criticality, wherein scheduling the project meeting includes determining an ordered agenda in which presentations for tasks for the project are presented for the project meeting.

2. The method of claim 1, wherein scheduling the project meeting further comprises:
allotting, based on the first criticality, a duration for a presentation for the first task for the project meeting.

3. The method of claim 1, wherein scheduling the project meeting further comprises:
receiving, from the project manager module, a first presentation type for the first task; and
allotting, based on the first presentation type, a duration for a presentation for the first task for the project meeting.

4. The method of claim 1, wherein determining the ordered agenda for the project meeting comprises one of:
scheduling to the beginning of the project meeting a presentation for a task having a lowest criticality; or
scheduling to the beginning of the project meeting a presentation for a task having a highest criticality.

5. The method of claim 1, wherein determining the ordered agenda for the project meeting comprises:
scheduling to the end of the project meeting a presentation for at least one task having a lowest criticality.

6. The method of claim 5 further comprising:
receiving an indication of when a presented presentation for the first task is concluded, wherein the presented presentation extended beyond a duration allotted for the presented presentation; and
responsively rescheduling an un-presented presentation for the second task, which has the lowest criticality, to a future project meeting.

7. The method of claim 6 further comprising:
selecting the second task to reschedule, from a plurality of tasks having the lowest criticality, based on an amount of time the presented presentation extended beyond the duration allotted for the presented presentation and based on a duration allotted for the un-presented presentation for the second task.

8. The method of claim 6 further comprising sending a notification to an account belonging to a participant associated with the second task, wherein the notification indicates at least one of:
a rescheduled time for the un-presented presentation for the second task; and
a rescheduled date for the un-presented presentation for the second task.

9. The method of claim 1 further comprising:
receiving an indication of when a presented presentation for the first task is concluded, wherein the presented presentation extended beyond a duration allotted for the presented presentation; and
responsively reducing an amount of time allotted for an un-presented presentation for the second task.

10. The method of claim 9 further comprising sending a notification to an account belonging to a participant associated with the second task, wherein the notification indicates at least one of:
a new scheduled time for the un-presented presentation for the first second; and
a new scheduled duration for the un-presented presentation for the second task.

11. The method of claim 1 further comprising:
receiving, from the project management module, an indication of a plurality of participants associated with the plurality of tasks, wherein determining the ordered agenda is further based on ordering the plurality of participants.

12. The method of claim 11 further comprising:
sending a notification to an account belonging to a first participant associated with the first task, wherein the notification indicates a scheduled time and duration for a presentation for the first task.

13. The method of claim 11, wherein determining the ordered agenda comprises:
scheduling presentations for a set of tasks associated with a first participant to reduce an attendance duration for the first participant at the project meeting.

14. The method of claim 13, wherein the first participant is associated with both the first task and second task, wherein scheduling the presentations for the set of tasks to reduce the attendance duration for the first participant comprises:
scheduling the presentations to minimize a time interval between a presentation for the first task and a presentation for the second task.

15. The method of claim 13, wherein the first participant is associated with both the first task and second task, wherein scheduling the presentations for the set of tasks to reduce the attendance duration for the first participant comprises:
scheduling the presentations to maximize a time interval between a presentation for the first task and a presentation for the second task.

16. An electronic computing device configured for scheduling project meetings, the electronic computing device comprising:
a meeting organizer module configured to:
receive, from a project manager module, a first criticality for a first task and a second criticality for a second task of a plurality of tasks for a project; and
schedule a project meeting for the project based on the first criticality and the second criticality, wherein scheduling the project meeting includes determining a first ordered agenda in which presentations for tasks for the project are presented for the project meeting.

17. The electronic computing device of claim 16, wherein the electronic computing device further comprises the project manager module communicatively coupled to the meeting organizer module, wherein the project manager module is configured to send to the meeting organizer module an indication of a plurality of participants associated with the plurality of tasks, wherein determining the ordered agenda is further based on ordering the plurality participants.

18. The electronic computing device of claim 17, wherein the meeting organizer module further comprises an attendance duration testing module configured to determine attendance durations for ordered agendas, wherein the meeting organizer module is configured to select the first ordered agenda over a second ordered agenda based on a first attendance duration for the first ordered agenda being less than a second attendance duration for the second ordered agenda.

19. The electronic computing device of claim 17, wherein the meeting organizer module further comprises a scheduler module configured to:
receive, from the project manager module, availability information indicating that a first participant associated with the first task is available at a second time of a future project meeting and that a second participant associated with the second task is unavailable at the second time; and
select, when a presented presentation for a task extends beyond a duration allotted for the presented presentation, an un-presented presentation for the first task over an un-presented presentation for the second task to reschedule from a first time of the project meeting to the second time of the future project meeting based on the availability information.

20. The electronic computing device of claim 16, wherein the electronic computing device further comprises:
at least one of a wireline interface and a transceiver communicatively coupled to the meeting organizer module, wherein the at least one of the wireline interface and the transceiver is configured to send a notification to an account belonging to a participant of the project meeting associated with the first task, wherein the notification indicates a time and duration for a presentation for the first task.
